(19) United States
(12) Patent Application Publication
(10) Pub. No.: US 2006/0005380 A1
(43) Pub. Date: Jan. 12, 2006

(54) Apparatus for arrange spacer of a field-emission display

(76) Inventor: Frank Yang, Guanyin Township (TW)

Correspondence Address: Yi-Wen Tseng, 4331 Stevens Battle Lane, Fairfax, VA, 22033, US

(21) Appl. No.: 10/883,706

(22) Filed: Jul. 6, 2004

(51) Int. Cl. B23P 19/00

(52) U.S. Cl. 29/743; 29/729; 29/834

(57) ABSTRACT

An apparatus for installing a spacer of a field-emission display is provided with a suction mechanism for sucking the spacer. The suction mechanism has a suction terminal, which an opening to apply suction force on top of the spacer and a positioning part located on top of the suction terminal for positioning the spacer sucked by the suction terminal. The suction terminal includes a pipe having a diameter smaller than that of the spacer. The positioning part is configured according to a configuration of the spacer. The opening has a uniform cross section from a bottom edge to a top surface thereof or a cross section gradually decreasing from a bottom edge to a top surface thereof.

### BACKGROUND OF THE INVENTION

The present invention relates in general to an apparatus for installing a spacer of a field-emission display, and more particularly, to an apparatus operative to provide suction force normal to the spacer, such that the spacer can be disposed between the anode and cathode boards and aligned therewith. Further, the apparatus uses a vacuum breaking device to prevent electrostatic charges from be generated, particularly during the removal of the spacer from the apparatus.

Currently, the bipolar, tripolar or tetrapolar field emission displays all contain a spacer 10 between the cathode and anode boards (as shown in FIGS. 1 and 2). The spacer 10 is designed to enhance the luminescent efficiency without overly reducing the breakdown voltage between the cathode and anode boards. Therefore, the space between the cathode and anode boards is typically maintained no smaller than 500 microns by the space 10. Therefore, the spacer 10 has to be strong enough to withstand the atmosphere pressure. At the same time, the spacer has to possess specific aspect ratio such that it is not visible to naked eyes. Normally, the width for the spacer 10 is about 500 to 100 micron, the height of the spacer 10 is between 800 and 2000 microns, and the length of the spacer 10 is about 2 to 4 millimeters. The shapes include cross and stripes. Those spacers selected from sodalime or similar material all experience of brittle, difficult to retrieve and align, and the complex fabrication.

The conventional installation of the spacer 10 includes a side suction method as shown in FIGS. 3 and 4. As shown, the clamp-type suction mechanism 30 is used to suck the spacer 10 at the side thereof. A CCD can be used to assist alignment. The drawback is than the side-suction results in a transverse reaction to display the spacer 10 when the spacer is removed from the suction mechanism. Further, as the material of the spacer easily generate electrostatic charges, particularly during removal of the spacer 10 from the suction mechanism, the spacer is difficult to be removed.

### BRIEF SUMMARY OF THE INVENTION

An apparatus for installing a spacer of a field-emission display is provided with a suction mechanism for sucking the spacer. The suction mechanism has a suction terminal, which an opening to apply suction force on top of the spacer and a positioning part located on top of the suction terminal for positioning the spacer sucked by the suction terminal. The suction terminal includes a pipe having a diameter smaller than that of the spacer. The positioning part is configured according to a configuration of the spacer. The opening has a uniform cross section from a bottom edge to a top surface thereof or a cross section gradually decreasing from a bottom edge to a top surface thereof.

An apparatus for installing a spacer of a field-emission display is further provided with a support member and a suction mechanism mounted to the support member. One end of the suction mechanism has an opening for applying a suction force to the spacer and a positioning part formed on the opening. The apparatus further has a gas transmission device.

An apparatus for installing a spacer of a field-emission display is also provided having a support member, a suction mechanism and a vacuum breaking device. One end of the suction mechanism is connected to the support member, and the other end of the suction mechanism has an opening for sucking the top portion of the spacer and a positioning part for aligning the spacer. The vacuum breaking device to provide an electrostatic removal gas to prevent electrostatic charges generated between the spacer and the suction mechanism.

### BRIEF DESCRIPTION OF THE DRAWINGS

The above objects and advantages of the present invention will be become more apparent by describing in detail exemplary embodiments thereof with reference to the attached drawings in which:

FIG. 1 shows the spacer used in the conventional field-emission display;

FIG. 2 shows another type of spacer used in the conventional field-emission display;

FIG. 3 is a top view of the conventional side-suction mechanism;

FIG. 4 is the side view showing the conventional side-suction mechanism;

FIG. 5 shows an apparatus for installing a spacer;

FIG. 6 is a rear view for a suction mechanism;

FIG. 7 shows the side view of the suction mechanism and the spacer;

FIG. 8 shows the top view of the suction mechanism and the spacer;

FIG. 9 shows the installment of the spacer;

FIG. 10 shows the side view of the suction mechanism; and

FIG. 11 shows another side view of the suction mechanism.

### DETAILED DESCRIPTION OF THE INVENTION

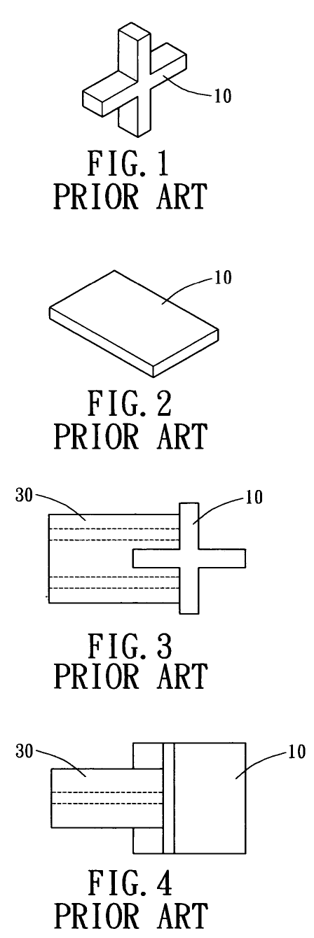

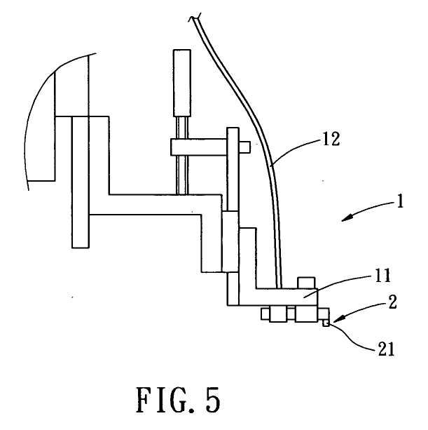

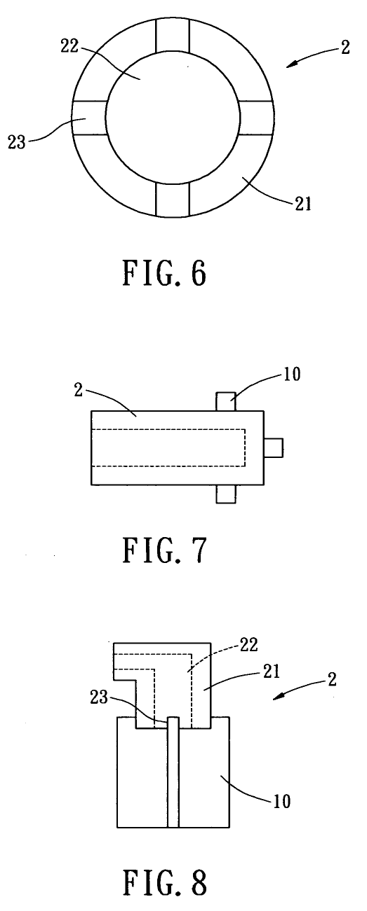

FIGS. 5 and 6 shows the rear view of an apparatus for installing a spacer and a suction structure. As shown, the apparatus for installing the spacer of a field-emission display uses suction force generated by the suction structure to suck the spacer 10 as shown in FIGS. 1 and 2. The spacer 10 is then installed between the anode board (not shown) and the cathode board (not shown) of the field-emission display. Thereby, the luminescent efficiency of the phosphor on the anode is enhanced, and the breakdown voltage between the anode board and the cathode board will not be too low to affect the image.

The suction structure includes support element 11 mounted to an installation device 1, a gas transmission device 12 connected to the suction structure 10 for venting the gas sucked by the suction structure 10, a suction mechanism, which includes a suction terminal and a suction opening 22 facing downwardly. A positioning part 23 for positioning or holding the spacer 10 sucked by the suction structure is formed on top of the suction terminal 22. The arrangement and configuration of positioning part 23 is variable according to the configuration of the spacer 10. The gauge of the suction mechanism 2 can be smaller than the spacer 10, such that the suction terminal 22 is operative to suck the spacer 10.

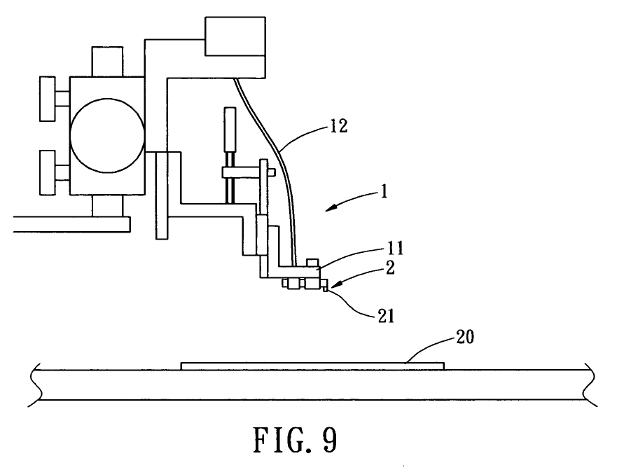

FIGS. 7-9 illustrate the side view, top view and installing status of the suction mechanism and the spacer. As shown, when the spacer 10 is attached to the suction terminal 21 of the suction mechanism 2, the spacer 10 is directly positioned within the positioning part 23. Meanwhile, the operator uses the CCD lens to view from the top, the edges of the spacer 10 can be observed for alignment with the anode board 20. When the spacer 10 and the anode board 20 are aligned with each other, the suction mechanism 2 is pressed downwardly by the installation apparatus, while the spacer 10 is lightly pressed to attach the anode board 20 by glass glue or paste (not shown).

In the process of sucking the spacer 10 by the suction mechanism, a vacuum breaking apparatus is used. The vacuum breaking apparatus provides an electrostatic removing gas, such that no electrostatic charge is generated during the suction process between the suction mechanism 2 and the spacer 10. The spacer 10 being sucked can then be detached from the suction mechanism 2 easily, and the installing action of the next spacer 10 can be taken action.

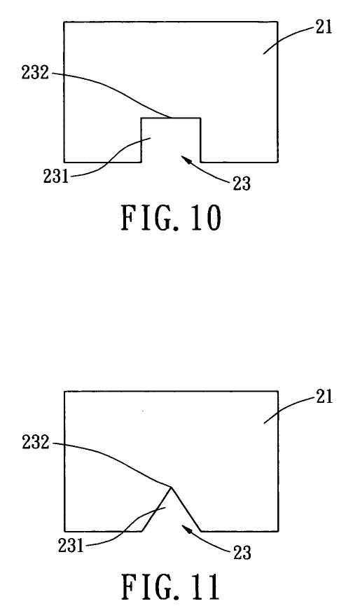

Further, the internal diameter of the positioning part 23 of the suctioning mechanism 2 allows the opening 231 having a constant diameter from the opening edge to the top surface thereof as shown in FIG. 10. Alternatively, the opening 231 is gradually contracted as shown in FIG. 11, such that the diameter of the opening is gradually reduced from the bottom edge to the top surface thereof. When the suction mechanism 2 sucks the spacer 10 thereto, the spacer 10 can be directly positioned on the positioning part, such that it is advantageous to install the spacer 10 on the anode board 20.

The embodiment as described above directly sucks the spacer and aligns the spacer 10 with the anode 20 via a CCD. Therefore, the labor and process for installing the spacer 10 are much reduced and simplify. Further, with the positioning part 23 formed on the suction mechanism 2, the suction mechanism is self-aligned with the spacer 10 while sucking the spacer. Therefore, repetitive alignment schedule is not required. Further, as the spacer 10 and the anode board 20 are pressed against, the attachment is more reliable, and the amount of glue can be reduced to prevent overflow of the glue which may very likely affect the vision area.

While the present invention has been particularly shown and described with reference to preferred embodiments thereof, it will be understood by those of ordinary skill in the art the various changes in form and details may be made therein without departing from the spirit and scope of the present invention as defined by the appended claims.

What is claimed is:

1. An apparatus for installing a spacer of a field-emission display, comprising:
a suctioning mechanism for sucking the spacer, the suction mechanism comprising:
a suction terminal, having an opening to apply suction force on top of the spacer; and
a positioning part located on top of the suction terminal for positioning the spacer sucked by the suction terminal.

2. The apparatus of claim 1, wherein the suction terminal includes a pipe having a diameter smaller than that of the spacer.

3. The apparatus of claim 1, wherein the positioning part is configured according to a configuration of the spacer.

4. The apparatus of claim 1, wherein the opening has a uniform cross section from a bottom edge to a top surface thereof.

5. The apparatus of claim 1, wherein the opening has a cross section gradually decreasing from a bottom edge to a top surface thereof.

6. An apparatus for installing a spacer of a field-emission display, comprising:
a support member; and
a suction mechanism mounted to the support member, one end of the suction mechanism having an opening for applying a suction force to the spacer and a positioning part formed on the opening.

7. The apparatus of claim 6, further comprising a gas transmission device.

8. An apparatus for installing a spacer of a field-emission display, comprising:
a support member;
a suction mechanism having one end connected to the support member, the suction mechanism having an opening for sucking the top portion of the spacer and a positioning part for aligning the spacer; and
a vacuum breaking device to provide an electrostatic removal gas to prevent electrostatic charges generated between the spacer and the suction mechanism.
